(19) United States
(12) Patent Application Publication
(10) Pub. No.: US 2023/0324492 A1
(43) Pub. Date: Oct. 12, 2023

(54) IRIS CAP FOR BEACON

(71) Applicant: Sheaumann Laser, Inc., Billerica, MA (US)

(72) Inventors: John Gary Sousa, Nashua, NH (US); Andrew Carlin, Acton, MA (US); James Skinner, Medford, MA (US)

(21) Appl. No.: 18/185,600

(22) Filed: Mar. 17, 2023

Related U.S. Application Data
(60) Provisional application No. 63/322,302, filed on Mar. 22, 2022.

(51) Int. Cl. G02B 5/00; G01S 1/70

(52) U.S. Cl. CPC G01S 1/7032; G02B 5/001

(57) ABSTRACT

An iris cap for a beacon is cylindrical in shape with defined wall length to create such an iris for the intended application. One application for example, an axicon will create defined output angle of emission dependent on the source emitter’s output angle and the axicon angle. Given the cost and difficulty of reproducing several MWIR/LWIR beacons for specific applications of maximum positive output angle, the Iris Cap introduces a simple solution. The Iris Cap can create specific maximum angles to reduce risk of over exposure of the beacon, simply by attaching the Iris Cap to the location of the emission with a countersunk screw.

### RELATED APPLICATIONS

This application claims the benefit under 35 USC 119(e) of U.S. Provisional Application No. 63/322,302, filed on Mar. 22, 2022, which is incorporated herein by reference in its entirety.

### BACKGROUND OF THE INVENTION

Deployable At-Sea Mid-Wave Infrared Emitter beacons provide visual position location for combat swimmer / diver personnel during rendezvous / extraction while in the ocean. The beacons often operate within the wavelength range of Mid-Wave and Long Wave Infrared (MWIR/LWIR), which is often defined as 2.0 ― 12.5 µm. Compatible imaging and sensing systems are then employed by pilots or spotters on ships, for example, to see and locate the beacons.

The MWIR/LWIR beacons emit in a “halo” of 360°. The halo emission also emits as a divergent output in azimuth both in the positive (towards the sky) and negative directions (towards the ground or ocean surface). FIG. 1A shows the beacon powered off and FIG. 1B shows the beacon on, with its cover screwed down and exposing the axicon.

FIGS. 2A and 2B are a side plan view and a side cross sectional view of the beacon 50.

Shown is the housing 1, the window cap 2, the cylindrical sapphire window, the base mount 4 including the quantum cascade laser (QCL), the contact pad 5, the QCL submount 6, the QCL housing mount 7; printed circuit board 8, cover 9, battery compartment 10, end cap 11, locking sleeve 12, switch slide 13, switch slide lock 14, switch 15, wet plugable connector 16, PCB at the top of the battery compartment 17, and PCB at the bottom of the battery compartment 18.

In operation, the beacon 50 is turned on by screwing the cover 9 down, which also serves as a protective cover when in the off position (fully threaded up) to protect the beacon if dropped.

### SUMMARY OF THE INVENTION

The amount of emission in the positive direction can be problematic given the intended recipient of the signal. It is costly to change or redesign the emission source that has defined the maximum angle for every intended use.

The present invention relates to the iris cap that functions as an iris for the beacon. The present iris cap allows the user to easily alter the maximum positive output range with interchangeable iris caps to obtain different iris effects. In general, the iris has cylindrical shape based on a defined wall length of the iris cap in the axial direction. In one example, the beacon creates defined output angle of emission dependent on the source emitter’s output angle and the axicon angle. Given the cost and difficulty of reproducing several MWIR/LWIR beacons for specific applications of maximum positive output angle, the iris cap introduces a simple solution. The iris cap can create specific maximum angles to limit high angle emission of the beacon, simply by attaching the iris cap to the window cap 2 or replacing the window cap 2 with the iris cap with a countersunk screw. The ease of alteration further allows field adjustment based on application/mission requirements.

In the past, an MWIR/LWIRIR beacon typically will have a defined positive and negative angle of emission that cannot be easily altered without changing a critical component or changing the mounting position of the laser component(s) of the MWIR/LWIR beacon.

In contrast, with the inventive iris cap, the user can easily adjust the iris of the MWIR/LWIR beacon axicon output based on their intended recipient. For example, an axicon can be used in an MWIR/LWIR beacon to produce a defined angled output of emission based on the machined mirror surface and angle of the axicon. This mirror surface is an expensive component that is difficult to machine and has a defined distance from the mounted laser component(s) to be an effective MWIR/LWIR beacon. The Iris Cap allows users to simply interchange these iris components in various embodiments based on their intended application as defined by the recipient height of the imaging or sensing system will be, such as from an aircraft, boat, etc.

In general, according to one aspect, the invention features a swappable iris cap that creates an iris for the MWIR/LWIR beacon emission.

Preferably, the iris cap comprises an annular wall having an extent defining an effective iris for the beacon emission.

In general, according to another aspect, the invention features a MWIR/LWIR beacon comprising a quantum cascade laser, an axicon for reflecting light from the laser to create a beacon, and iris cap that creates an iris for the beacon.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1A is a side perspective views showing a beacon powered off and FIG. 1B is a side perspective view showing the beacon powered on;

FIGS. 2A and 2B are a side plan view and a side cross sectional view of the beacon;

FIG. 3 is a side plan view of inventive Iris Cap;

FIG. 4 is a top-to-bottom isometric view of the Iris Cap;

FIG. 5 is a bottom-to-top isometric view of the iris cap;

FIG. 6A is a partial top view of a conventional beacon with the top cap;

FIG. 6B partial top view of a beacon 50 with the inventive iris cap; and

FIG. 7 is a pictorial representation of an aircraft relative to a MWIR/LWIR emitter beacon.

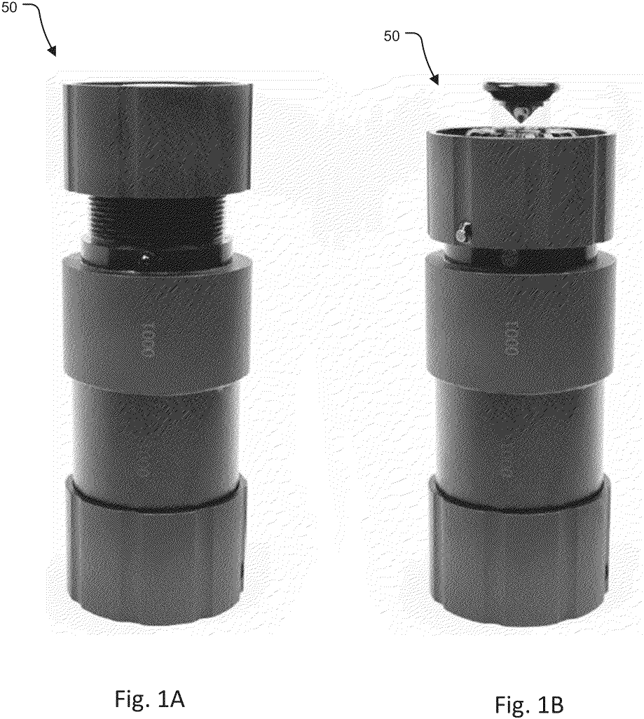

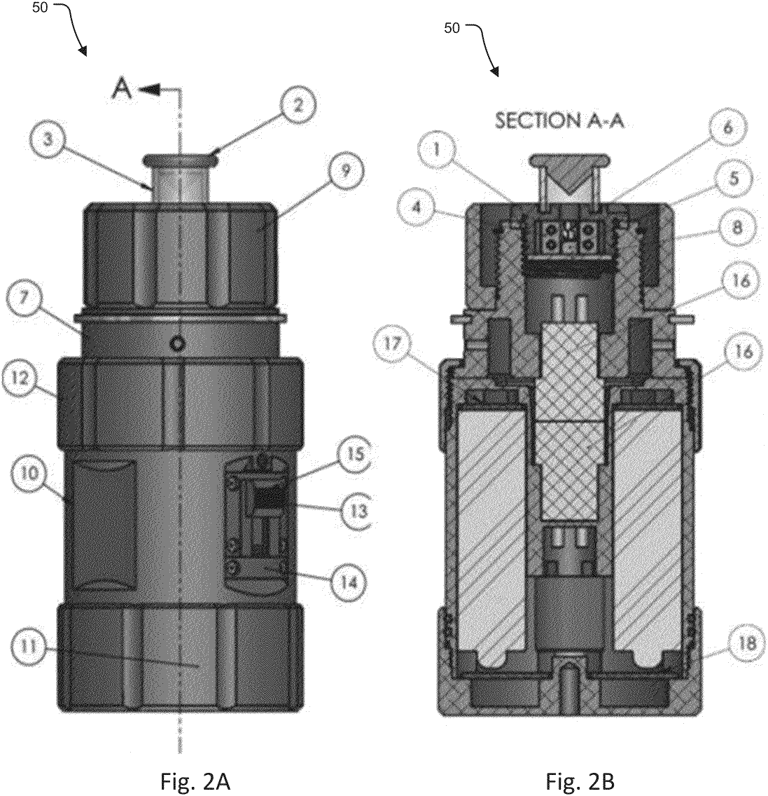

### DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

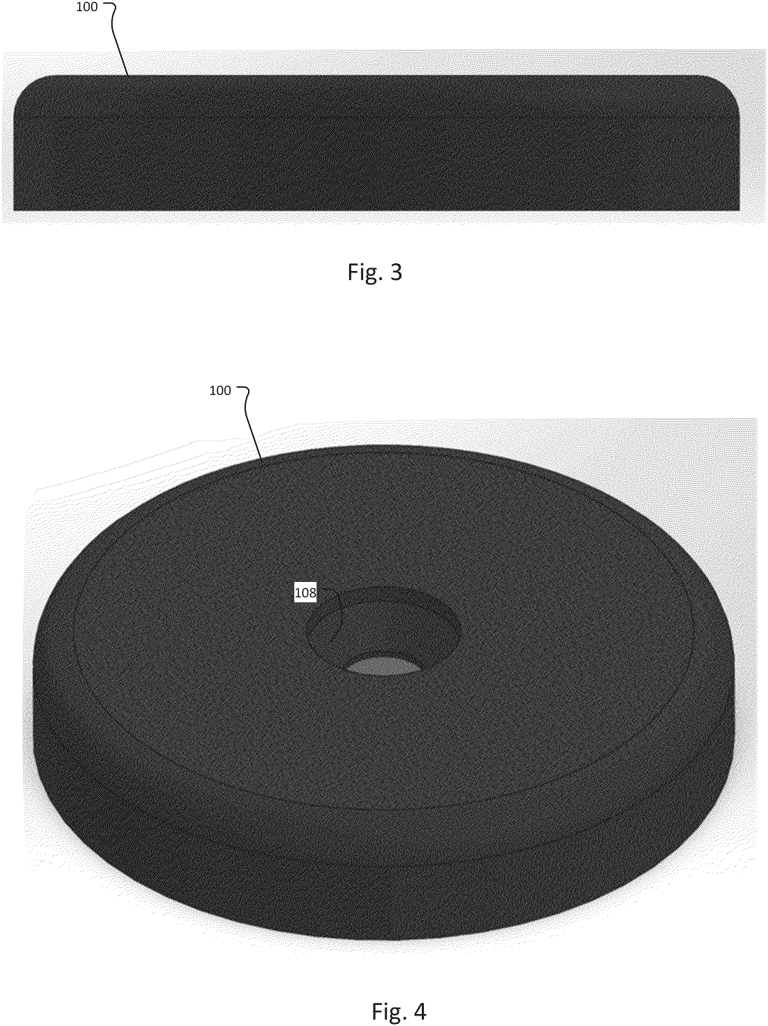

FIG. 3 is a side plan view of the Iris Cap 100.

FIG. 4 is a top-to-bottom isometric view of the Iris Cap 100. This view shows the simple mounting of the cap via a countersunk hole 108 for a countersunk screw.

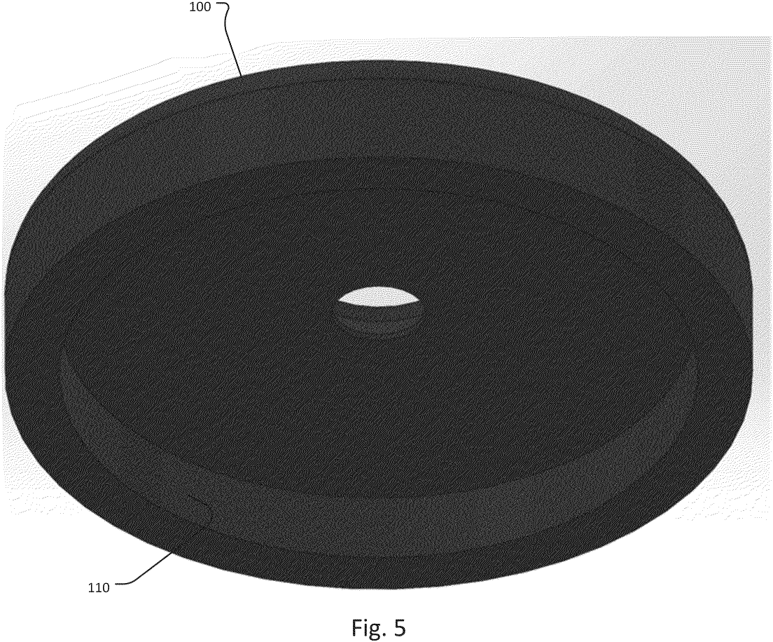

FIG. 5 is a bottom-to-top isometric view of the Iris Cap 100. This view captures the annular iris wall 110 on the outer diameter of the Iris Cap. The extent of this wall 110 in the axial direction defines the effective iris of the beacon.

This view shows how the outer wall protruding down. Thus, this wall 110 creates the iris effect of the accompanying MWIR/LWIR beacon. This wall 110 is increase or decrease in length to create a different iris effects on the MWIR/LWIRIR beacon and reduce the maximum output angle of the emission.

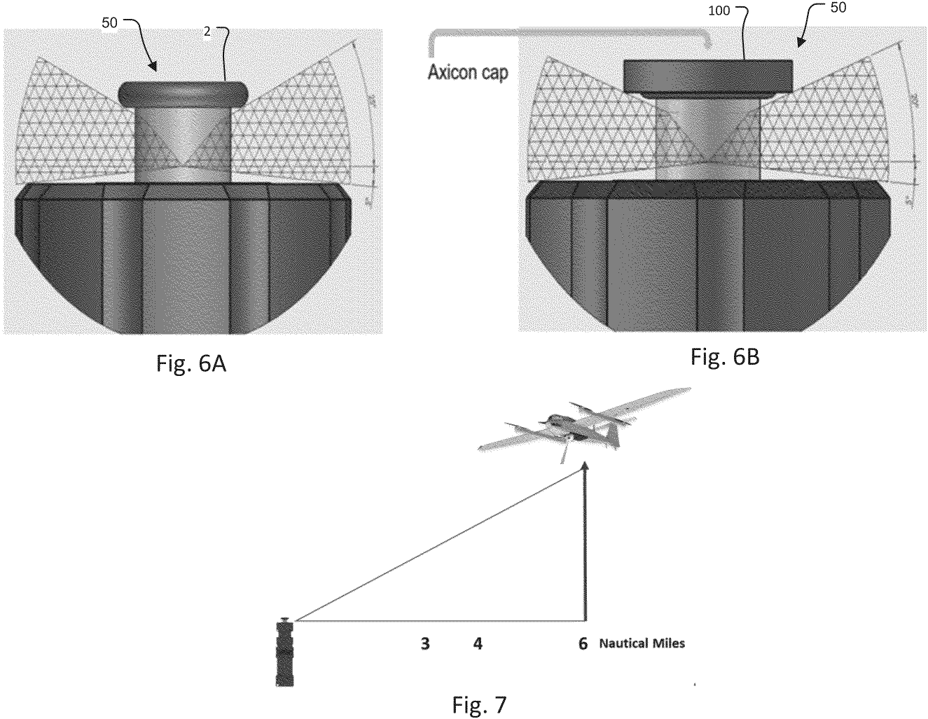

FIG. 6A is a partial top view of a conventional beacon with the top cap and FIG. 6B partial top view of a beacon 50 with the inventive iris cap 100. These figures show the axicon before and after adding the Iris Cap. Before attaching the cap, the positive angle of emission is at 25°, then after adding an Iris Cap 100 the positive angle is limited to only a positive angle of 20°. And this positive angle can be easily adapted to different missions by changing to a different iris cap provide a different emission angle.

Table 1 for a simple breakdown of the various heights the MWIR/LWIR beacon could be identified from assuming a point source of emission that spreads from 0° to the maximum angle declared in the table. Assume the emission can be detected up to 6 nautical miles.

TABLE 1

| Max angle | 3 Nautical Miles | 4 Nautical Miles | 6 Nautical Miles |
|---|---|---|---|
| 25° | 8500 ft | 11333 ft | 17000 ft |
| 15° | 4884 ft | 6512 ft | 9769 ft |
| 10° | 3214 ft | 4280 ft | 6428 ft |

This data assumes a point source, and a detectable emission spanning from 0° to the maximum angle in the left most column. This also assumes the MWIR/LWIRIR emission source can emit over a distance up to 6 nautical miles. This table depicts how high up the MWIR/LWIRIR beacon can be seen from at these axicon defined positive angles of emission.

For example, if the user’s recipient camera or sensing system were on a boat, they may elect to only want an output of 15° to limit the maximum height over distance of their signal to reduce risk of alternative imaging or sensing systems on an aircraft from detecting their signal.

FIG. 7 is a pictorial representation, in support of table 1, of an aircraft relative to a MWIR/LWIR emitter being within the emission halo of the device based on high angle emission.

While this invention has been particularly shown and described with references to preferred embodiments thereof, it will be understood by those skilled in the art that various changes in form and details may be made therein without departing from the scope of the invention encompassed by the appended claims.

What is claimed is:

1. A swappable iris cap that creates an iris for the MWIR/LWIR beacon emission.

2. The iris cap as claimed in claim 1, wherein the iris cap comprises an annular wall having an extent defining an effective iris for the beacon emission.

3. A MWIR/LWIR beacon comprising
a quantum cascade laser;
an axicon for reflecting light from the laser to create a beacon; and
iris cap that creates an iris for the beacon.

4. The beacon as claimed in claim 3, wherein the iris cap is swappable.

5. The beacon as claimed in claim 3, wherein the iris cap comprises an annular wall having an extent defining an effective iris for the beacon emission.
